(19) United States
(12) Patent Application Publication
(10) Pub. No.: US 2018/0233929 A1
(43) Pub. Date: Aug. 16, 2018

(54) BATTERY TO BATTERY CHARGER USING ASYMMETRIC BATTERIES

(71) Applicant: Spiers New Technologies, Inc., Nichols Hills, OK (US)

(72) Inventor: Bryan Schultz, Oklahoma City, OK (US)

(21) Appl. No.: 15/431,324

(22) Filed: Feb. 13, 2017

(51) Int. Cl. H02J 7/00

(52) U.S. Cl. CPC H02J 7/0021; H02J 7/0045

(57) ABSTRACT

A battery charging station including a first battery, a second battery, a boost converter and at least one battery charger is disclosed. The first battery has a first positive terminal and a first negative terminal and produces a first voltage. The second battery has a second positive terminal and a second negative terminal and producing a second voltage. The boost converter is coupled in series between the first battery and the second battery and is configured to selectively produce a third voltage at the second negative terminal greater than the first voltage. The battery charger has first leads coupled to the first positive terminal and the second negative terminal, and second leads coupled to the second positive terminal and the second negative terminal for charging the first battery and the second battery from an external power source.

### INCORPORATION BY REFERENCE

Not Applicable.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### BACKGROUND OF THE INVENTION

A rechargeable battery, storage battery, secondary cell, or accumulator is a type of electrical battery which can be charged, discharged into a load, and recharged many times, while a non-rechargeable or primary battery is supplied fully charged, and discarded once discharged. Rechargeable batteries are composed of one or more electrochemical cells. The term “accumulator” is used as it accumulates and stores energy through a reversible electrochemical reaction. Rechargeable batteries are produced in many different shapes and sizes, ranging from button cells to megawatt systems connected to stabilize an electrical distribution network. Several different combinations of electrode materials and electrolytes are used, including lead-acid, nickel cadmium (NiCd), nickel metal hydride (NiMH), lithium ion (Li-ion), and lithium ion polymer (Li-ion polymer).

Rechargeable batteries are used for many applications including powering automobiles, portable consumer devices, light vehicles (such as motorized wheelchairs, golf carts, electric bicycles, and electric forklifts), tools, and uninterruptible power supplies. Emerging applications in hybrid internal combustion-battery and electric vehicles are driving the technology to reduce cost, weight, size, and increase lifetime. Grid energy storage applications use rechargeable batteries for load-leveling, storing electric energy at times of low demand for use during peak periods, and for renewable energy uses, such as storing power generated from photovoltaic arrays during the day to be used at night. Load-leveling reduces the maximum power which a plant must be able to generate, reducing capital cost and the need for peaking power plants.

Rechargeable batteries include a positive active material, a negative active material and in some cases an electrolyte. The positive active material and the negative active material are disposed in the electrolyte. During charging, the positive active material is oxidized, producing electrons, and the negative material is reduced, consuming electrons. These electrons constitute a current flow in a circuit external to the rechargeable battery. The electrolyte may serve as a buffer for internal ion flow between the electrodes, as in lithium-ion and nickel-cadmium cells, or the electrolyte may be an active participant in the electrochemical reaction, as in lead-acid cells.

The energy used to charge rechargeable batteries usually comes from a battery charger using AC mains electricity, or an alternator driven by a separate motive source such as an engine. Regardless of the source of energy, to store energy in a rechargeable battery, the rechargeable battery has to be connected to a DC voltage source. This is accomplished by connecting a negative terminal of the rechargeable battery to a negative terminal of a power source and a positive terminal of the power source to a positive terminal of the rechargeable battery. Further, a voltage output of the power source must be higher than that of the rechargeable battery, but not much higher: the greater the difference between the voltage of the power source and the battery's voltage capacity, the faster the charging process, but also the greater the risk of overcharging and damaging the rechargeable battery.

Battery charging and discharging rates are often discussed by referencing a “C” rate of current. The C rate is that which would theoretically fully charge or discharge the battery in one hour. For example, trickle charging might be performed at C/20 (or a “20 hour” rate), while typical charging and discharging may occur at C/2 (two hours for full capacity).

In some cases, rechargeable battery packs are formed of multiple electrochemical cells (hereinafter “cells”) that are connected together in a series or parallel configuration. The capacity within cells of the various rechargeable battery packs vary depending on the discharge rate. Some energy is lost in the internal resistance of cell components (plates, electrolyte, interconnections), and the rate of discharge is limited by the speed at which chemicals in the cell can move about. For lead-acid cells, the relationship between time and discharge rate is described by Peukert's law; a lead-acid cell that can no longer sustain a usable terminal voltage at a high current may still have usable capacity, if discharged at a much lower rate. Data sheets for rechargeable cells often list the discharge capacity on 8-hour or 20-hour or other stated time; cells for uninterruptible power supply systems may be rated at 15 minute discharge.

Battery manufacturers' technical notes often refer to voltage per cell (VPC) for the individual cells that make up the battery. For example, to charge a 12 V lead-acid battery (containing 6 cells of 2 V each) at 2.3 VPC requires a voltage of 13.8 V across the battery's terminals.

Shown in FIG. 1 is a block diagram of a conventional battery charging station 10 for charging a battery pack 12 within an automobile 14. Power is supplied to the battery charging station 10 from an electric grid 16. The cost to be paid for the electricity to the electric utility is based on a combination of dollars per kilowatt hour and peak charges. To avoid substantial peak charges, the battery charging station 10 is provided with a battery pack 18 that is charged during off-peak time periods with the use of a bidirectional inverter 20. The battery pack 18 and the bidirectional inverter 20 preferentially supplies current to and charges the battery pack 12 during time periods when the peak charges are substantial. The battery charging station 10 is also provided with an electric vehicle supply equipment control 22 that uses two-way communication between the battery charging station 10 and the automobile 14 to set a correct charging current based on a maximum current the battery charging station 10 can provide as well as a maximum current the automobile 14 can receive. Once the correct charging current is set, the battery charging station 10 supplies electrical current from either one or both of the electrical grid 16 and the battery pack 18 to the battery pack 12 within the automobile 14 and the electric vehicle supply equipment control 22.

Shown in FIG. 2 is a block diagram of another conventional battery charging station 30 that includes a battery pack 32 and a trickle charger 34. The trickle charger 34 is connected to the electrical grid 16 and receives power therefrom. The trickle charger 34 continuously charges and maintains the battery pack 32. The voltage of the battery pack 32 is either higher or lower than the voltage of the battery pack 12 within the automobile. To raise the voltage of the battery pack 32 above the voltage of the battery pack 12, current is supplied from the battery pack 32 to the battery pack 12 through a DC to DC converter 38.

In the conventional battery charging stations 10 and 30, the voltage supplied to the battery pack 12 is typically in a range from 300-400 Volts. Because, all of the charging current passes through semiconductor switches utilized in the bidirectional inverter 20 and the DC to DC converter 38, semiconductor switches that are rated for more than the voltage supplied to the battery pack 12 must be used. This increases the costs and decreases the efficiency of the battery charging stations 10 and 30. It would be advantageous to develop a battery charging station that does not require a semiconductor switch having a rating higher than the voltage being supplied to the battery pack 12, thereby reducing the cost and increasing the efficiency of the battery charging station. Ideally, it would be advantageous to develop a battery charging station that can use semiconductor switches having a voltage rating of 12, 24, or 48 V thereby reducing the cost and increasing the efficiency of the battery charging station. It is to such an improved battery charging station that the present disclosure is directed.

### BRIEF DESCRIPTION OF THE DRAWINGS

To assist those of ordinary skill in the relevant art in making and using the subject matter hereof, reference is made to the appended drawings, which are not intended to be drawn to scale, and in which like reference numerals are intended to refer to similar elements for consistency. For purposes of clarity, not every component may be labeled in every drawing.

FIG. 1 is a block diagram of a conventional battery charging station.

FIG. 2 is a block diagram of another type of conventional battery charging station.

FIG. 3 is a block diagram of an exemplary hardware configuration of part of a vehicle in accordance with an embodiment of the present disclosure.

FIG. 4 is a block diagram of an exemplary battery pack shown in FIG. 3 and illustrating multiple battery units connected in series.

FIG. 5 is a block diagram of a battery charging system including a battery charging station constructed in accordance with the present disclosure being used to charge a battery pack in accordance with the present disclosure.

FIG. 6 is a block diagram of an exemplary boost converter of the battery charging station depicted in FIG. 5.

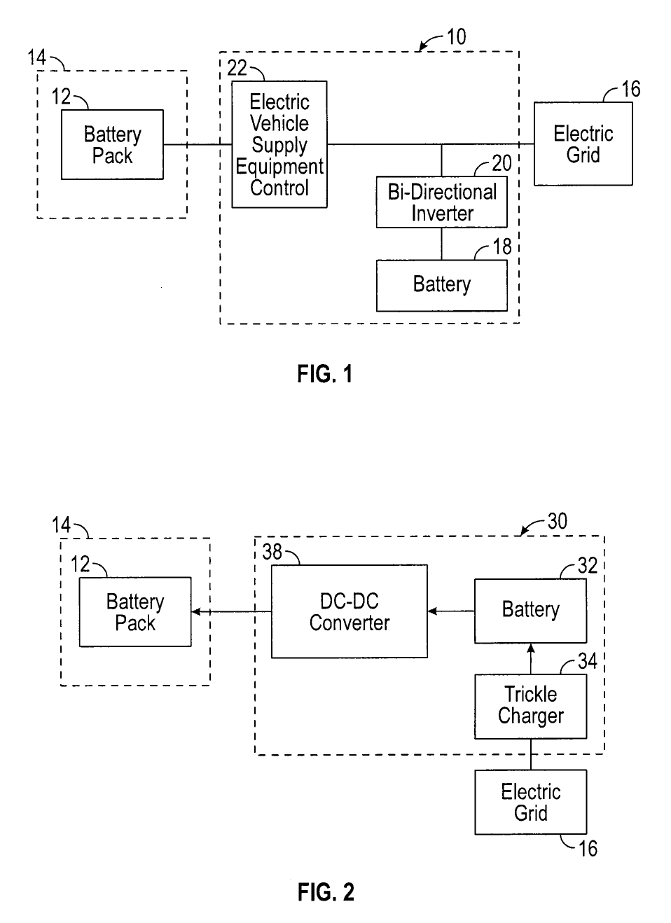

### DETAILED DESCRIPTION OF EXEMPLARY EMBODIMENTS

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. The inventive concepts disclosed herein are capable of other embodiments, or of being practiced or carried out in various ways. Also, it is to be understood that the phraseology and terminology employed herein is for the purpose of description and should not be regarded as limiting the inventive concepts disclosed and claimed herein in any way.

In the following detailed description of embodiments of the inventive concepts, numerous specific details are set forth in order to provide a more thorough understanding of the inventive concepts. However, it will be apparent to one of ordinary skill in the art that the inventive concepts within the instant disclosure may be practiced without these specific details. In other instances, well-known features have not been described in detail to avoid unnecessarily complicating the instant disclosure.

As used herein, the terms “comprises,” “comprising,” “includes,” “including,” “has,” “having,” and any variations thereof, are intended to cover a non-exclusive inclusion. For example, a process, method, article, or apparatus that comprises a list of elements is not necessarily limited to only those elements, and may include other elements not expressly listed or inherently present therein.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B is true (or present).

In addition, use of the “a” or “an” are employed to describe elements and components of the embodiments disclosed herein. This is done merely for convenience and to give a general sense of the inventive concepts. This description should be read to include one or at least one and the singular also includes the plural unless it is obvious that it is meant otherwise.

As used herein, qualifiers like “substantially,” “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

The term “battery unit” as used herein means an individual battery cell, or multiple battery cells permanently connected together to form a module.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Embodiments of the present invention will hereinafter be described in detail with reference to the drawings.

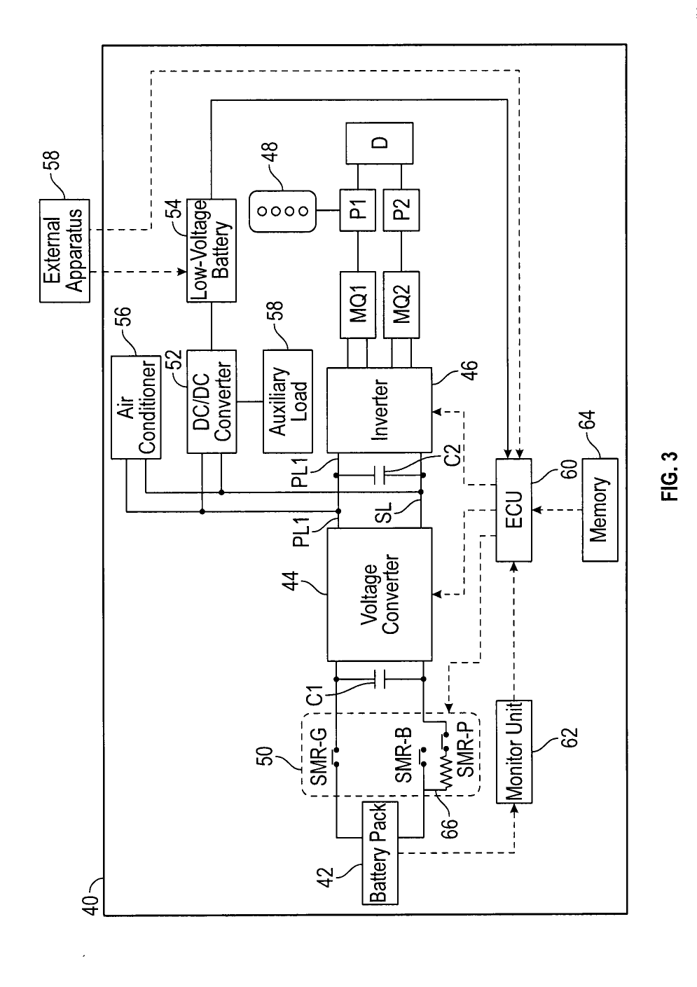

Referring now to the drawings, and in particular to FIG. 3, shown therein is a block diagram of an exemplary hardware configuration of part of a vehicle 40 in accordance with an embodiment of the present disclosure. In some embodiments, the vehicle 40 is a conventional vehicle that is described and shown in block diagram form in PCT/JP2011/005399. The following discussion of FIG. 3 was modeled on the description of the vehicle 10 in PCT/JP2011/005399. In FIG. 3, an arrow indicated by a solid line represents the direction of power supply, and arrows indicated by dotted lines represent the directions of signal transmission. The vehicle 40 can be a hybrid car which has a driving system for driving a motor using the output from a battery pack 42 and a driving system with an engine. The vehicle 40 can also be an all-electrically powered vehicle.

Referring to FIG. 3, the vehicle 40 includes the battery pack 42, smoothing capacitors C1 and C2, a voltage converter 44, an inverter 46, a motor generator MG1, a motor generator MG2, a power splitting planetary gear P1, a reduction planetary gear P2, a decelerator D, an engine 48, a relay 50, a DC/DC converter 52, a low-voltage battery 54, an air conditioner 56, an auxiliary load 58, an electronic control unit (“ECU”) 60, a monitor unit 62, and a memory 64.

The battery pack 42 can be provided by using an assembled battery including a plurality of battery units connected in series. Examples of the battery units can include a nickel metal hydride battery, a nickel cadmium battery, or a lithium-ion battery. The vehicle 40 also includes a power source line PL1 and a ground line SL. The battery pack 42 is connected to the voltage converter 44 through system main relays SMR-G, SMR-B, and SMR-P which constitute the relay 50.

The system main relay SMR-G is connected to a positive terminal of the battery pack 42, and the system main relay SMSR-B is connected to a negative terminal of the battery pack 42. The system main relay SMR-P and a precharge resistor 36 are connected in parallel with the system main relay SMR-B.

In this embodiment, the system main relays SMR-G, SMR-B, and SMR-P are relays having contacts that are closed when their coils are energized. “ON” of the SMR means an energized state, and “OFF” of the SMR means a nonenergized state.

In the embodiment shown, the ECU 60 turns off all the system main relays SMR-G, SMR-B, and SMR-P while the power is shut off, that is, while an ignition switch is at an OFF position. Specifically, the ECU 60 turns off the current for energizing the coils of the system main relays SMR-G, SMR-B, and SMR-P. The position of the ignition switch is switched in the order from the OFF position to an ON position. The ECU 60 may be a central processing unit (“CPU”) or a microprocessing unit (“MPU”), and may include an application specific integrated circuit which performs, based on circuital operation, at least part of processing executed in the CPU or the like. In this embodiment, the ECU 60 starts up by receiving the power supply from the low-voltage battery 54.

Upon start-up of a hybrid system (upon connection to a main power source), that is, for example when a driver steps on a brake pedal and depresses a start switch of push type, the ECU 60 first turns on the system main relay SMR-G. Next, the ECU 60 turns on the system main relay SMR-P to perform precharge.

The precharge resistor 66 is connected to the system main relay SMR-P. Thus, even when the system main relay SMR-P is turned on, the input voltage to the inverter 46 can be slowly increased to prevent the occurrence of an inrush current. When the ignition switch is switched from the ON position to the OFF position, the ECU 60 first turns off the system main relay SMR-B and then turns off the system main relay SMR-G. This breaks the electrical connection between the battery pack 42 and the inverter 46 to enter a power shut-off state. The system main relays SMR-B, SMR-G, and SMR-P are controlled for energization or non-energization in response to a control signal provided by the ECU 60.

The capacitor C1 is connected between the power source line PL1 and the ground line SL and smoothes an inter-line voltage. The DC/DC converter 52 and the air conditioner 56 are connected in parallel between the power source line PL1 and the ground line SL. The DC/DC converter 52 drops the voltage supplied by the battery pack 42 to charge the low-voltage battery 54 or to supply the power to an auxiliary load 58. The auxiliary load 58 may include an electronic device such as a lamp and an audio for the vehicle, not shown.

The voltage converter 44 increases an inter-terminal voltage of the capacitor Cl. The capacitor C2 smoothes the voltage increased by the voltage converter 44. The inverter 46 converts the DC voltage provided by the voltage converter 44 into a three-phase AC current and outputs the AC current to the motor generator MG2. The reduction planetary gear P2 transfers a motive power obtained in the motor generator MG2 to the decelerator D to drive the vehicle. The power splitting planetary gear P1 splits a motive power obtained in the engine 48 into two. One of them is transferred to wheels through the decelerator D, and the other drives the motor generator MG1 to perform power generation.

The power generated in the motor generator MG1 is used for driving the motor generator MG2 to assist the engine 48. The reproduction planetary gear P2 transfers a motive power transferred through the decelerator D to the motor generator MG2 during the deceleration of the vehicle to drive the motor generator MG2 as a power generator. The power obtained in the motor generator MG2 is converted from a three-phase AC current, for example, into a DC current in the inverter 46 and is transferred to the voltage converter 44. In this case, the ECU 60 performs control such that the voltage converter 44 operates as a step-down circuit. The power at the voltage dropped by the voltage converter 44 is stored in the battery pack 42.

The monitor unit 62 obtains the information about the voltage, current, and temperature of the battery pack 42. The monitor unit 62 is formed as a unit integral with the battery pack 42. The voltage value obtained by the monitor unit 62 may be the voltage value of each battery unit (cell) when the secondary batteries constituting the battery pack 42 are Nickel Metal Hydride, Nickel Cadmium or lithium-ion batteries, for example. The voltage value detected by the monitor unit 62 may be the voltage value of each of battery modules (cell groups each including a plurality of battery units connected in series) when the secondary batteries constituting the battery pack 42 are the nickel metal hydride batteries. The temperature of the battery pack 42 may be obtained through a thermistor, not shown.

The memory 64 stores the information about a control upper limit value and a control lower limit value of an electric storage amount for use in charge and discharge control of the battery pack 42. The ECU 60 performs control such that the electric storage amount in the battery pack 42 is maintained within a control range defined by the control upper limit value and the control lower limit value. The ECU 60 suppresses charge when the electric storage amount in the battery pack 42 exceeds the control upper limit value. The ECU 60 prohibits the charge and discharge of the battery pack 42 when the electric storage amount in the battery pack 42 reaches an electric storage amount corresponding to a charge termination voltage higher than the control upper limit value. The state in which the battery pack 42 reaches the charge termination voltage or exceeds the charge termination voltage is referred to as an overcharged state.

The ECU 60 suppresses discharge when the electric storage amount in the battery pack 42 falls below the control lower limit value. The ECU 60 prohibits the charge and discharge of the battery pack 42 when the electric storage amount in the battery pack 42 reaches an electric storage amount corresponding to a discharge termination voltage lower than the control lower limit value. The state in which the electric storage amount in the battery pack 42 reaches a discharge termination voltage or falls below the discharge termination voltage is referred to as an overdischarged state.

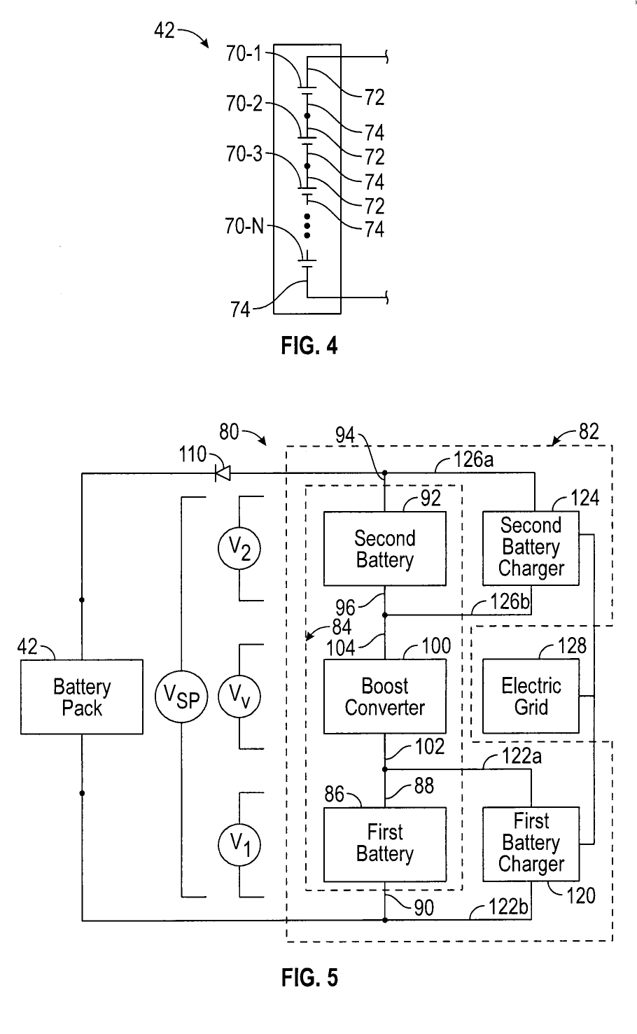

As shown in FIG. 4, the battery pack 42 is provided with a plurality of battery units 70. By way of example, four battery units 70 are depicted in FIG. 4 and designated as 70-1, 70-2, 70-3 and 70-n. It should be understood that the battery pack 42 can have any number of battery units 70 and typically will have 28, 30, 38, 40, 48, or 96 battery units 70. In the example discussed herein, the battery pack 42 will have 96 battery units 70, connected in a 1P series configuration. The battery units 70 have a positive terminal 72 and a negative terminal 74. The battery units 70 can be combined in a series configuration in which the positive terminal 72 of one of the battery units 70 is connected to the negative terminal 74 of an adjacent battery unit 70. The ECU 60 is provided at a position separate from the battery pack 42. Alternatively, the ECU 60 and the battery pack 42 may be formed as a unit. As will be understood by one skilled in the art, when the battery units 70 are lithium-ion batteries, each of the battery units 70 have a nominal voltage normally within a range from about 3.7 V to about 4.2 V. When the battery pack 42 includes 96 battery units 70 (e.g., of a lithium-ion type) in a series configuration, the battery pack will have a battery pack voltage from about 355.2 to about 403.2 V. As one skilled in the art will understand, the battery units 70 can be provided with other nominal voltages, and the voltages of the battery units 70 at any instant of time will be depend upon a number of factors including the state of charge or discharge of the battery units 70. In some embodiments, battery units 70 which have a nominal voltage of 4.2 V may have a fully discharged voltage of about 3.4 V. Thus, when the battery pack 42 includes 96 battery units 70 having a nominal voltage of 4.2 V, the voltage of the battery pack 42 can vary between 403.2 V and 326.4 V.

Referring now to FIG. 5, shown therein is a battery charging system 80 provided with a battery charging station 82 connected to the battery pack 42 within the vehicle 40 for providing current to the battery pack 42 and thereby charging the battery pack 42 from power supplied by the battery charging station 82. The battery charging station 82 is provided with a stationary power source 84 that has a variable voltage potential Vₛₚ that in an uncharging state is below the battery pack voltage of the battery pack 42 at a fully discharged state, i.e., at any amount of charge, and in a charging state is equal to or greater than the battery pack voltage.

The stationary power source 84 is provided with a first battery 86 having a first positive terminal 88 and a first negative terminal 90 and producing a first voltage V₁ between the first positive terminal 88 and the first negative terminal 90. The stationary power source 84 is also provided with a second battery 92 having a second positive terminal 94 and a second negative terminal 96 and producing a second voltage V₂ between the second positive terminal 94 and the second negative terminal 96.

The stationary power source 84 is also provided with a boost converter 100 having an input port 102 coupled to the first positive terminal 88 and an output port 104 coupled to the second negative terminal 96 and producing a variable voltage Vᵥ at the second negative terminal 96 that is added to the first voltage V₁. The boost converter 100 can be actuated to switch the stationary power source 84 from the uncharging state to the charging state, and de-actuated to switch the stationary power source 84 from the charging state to the uncharging state. When the boost converter 100 is not actuated, the variable voltage Vᵥ can be zero, and when the boost converter 100 is actuated, the variable voltage Vᵥ is above zero. The amount above zero that the variable voltage Vᵥ is set, can be based upon a variety of factors including the nominal voltage of the battery pack 42, the fully discharged voltage of the battery pack 42, or a pre-defined charging current.

Because the second battery 92 is in series with the boost converter 100, the variable voltage of the voltage Vₛₚ is the sum of V₁, Vᵥ, and V₂. In the example discussed herein in which the battery pack 42 is provided with 96 battery units 70 having a nominal voltage of 4.2 V and a fully discharged voltage of 3.4 V, the variable voltage Vₛₚ should be in a range from below 326.4 V (the voltage of the battery pack 42 in a fully discharged state) to 1-5 V above 403.2 V (the voltage of the battery pack 42 in a fully charged state). The amount that the variable voltage Vₛₚ may be below the voltage of the battery pack 42 in the fully discharged state varies, but may be about 10% (e.g. approximately 302 V) to prevent the stationary power source 84 from inadvertently charging the battery pack 42 in the uncharging state. A diode 110 may also be used to prevent the battery pack 42 from inadvertently charging the stationary power source 84.

In this example, upon actuation, the boost converter 100 generates a voltage Vᵥ of about 103 V when actuated. Thus, the variable voltage Vₛₚ in the charging state in this example is 405 V, which is 1.8 V higher than the nominal voltage of the battery pack 42 in the present example.

The battery charging station 82 is also provided with at least one battery charger. In the example shown in FIG. 5, the battery charging station 82 is provided with a first battery charger 120 having first leads 122a and 122b coupled to the first positive terminal 88 and the second negative terminal 90, and a second battery charger 124 having second leads 126a and 126b coupled to the second positive terminal 94 and the second negative terminal 96 for charging and maintaining the first battery 86 and the second battery 92 from an external power source, such as an electric grid 128. Other types of external power sources can be used, such as a wind generation source, a solar power source, or the like.

The first and second voltages V₁ and V₂ of the first battery 86 and the second battery 92 are asymmetric, or in other words, not equal to one another. The voltage V₁ of the first battery V₁ is less than the voltage V₂. The first and second voltages V₁ and V₂ can vary so long as the first voltage remains less than the second voltage V₂. In some embodiments, the first voltage V₁ is in a range from 2% to 50% of the second voltage V₂. In some embodiments, the first voltage V₁ is less than or equal to 48 volts.

In one embodiment, the first battery 86 includes a plurality of first battery units 70 interconnected so as to provide X first battery units 70 in series and Y first battery units 70 in parallel, and the second battery 92 includes a plurality of second battery units 70 interconnected so as to provide A second battery units 70 in series and B second battery units 70 in parallel, where X is greater than A, and B is greater than Y. In one example, the first battery 86 is provided with 56 battery units 70 arranged in a four series 14 parallel configuration, and the second battery 92 is provided with 136 battery units 70 arranged in a 68 series 2 parallel configuration. Assuming a nominal voltage of each of the battery units 70 of 4.2 volts, then the first voltage V₁ is 16.8 V, and the second voltage V₂ is 285.6 V. In this example, the first voltage V₁ is 5.8% of the second voltage V₂. Thus, one skilled in the art will understand that the first battery 86 has a lower voltage than the second battery 92, but has the ability to supply a higher electrical current than the second battery 92. X, Y, A and B can change based upon the expected voltage of the battery pack 42 prior to and after charging, as well as the desired capacity of the stationary power source 84.

Thus, the first voltage V₁ that is presented to the boost converter 100 is much lower than the sum of the voltages V₁ and V₂ that would be presented to the bi-directional inverter 20, or the DC to DC converter 38 in the conventional battery charging stations 10 and 30. This permits the boost converter 100 to be made with much less expensive and more efficient components. Also, by providing the first battery 86 with the ability to supply a higher electrical current than the second battery 92, the first battery 86 can supply current to the battery pack 42, and also supply current to the boost converter 100 (when actuated) to permit the boost converter 100 to generate the variable voltage Vᵥ in the charging state, as discussed above.

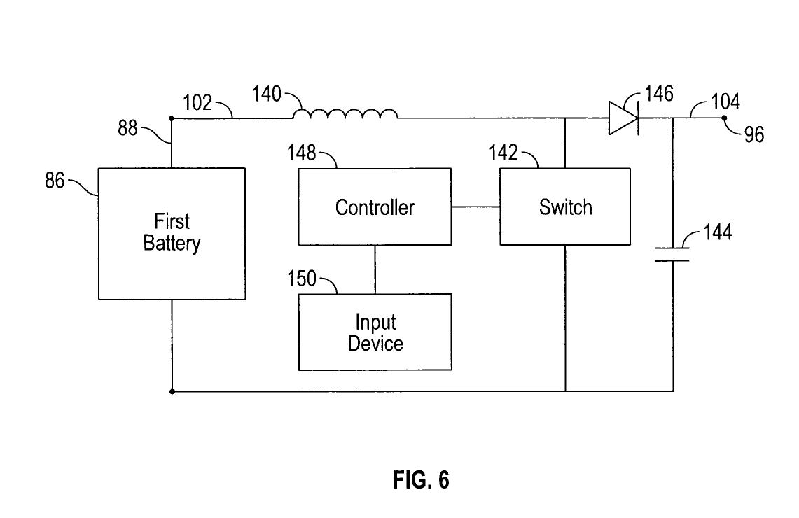

Shown in FIG. 6 is a schematic diagram of an exemplary boost converter 100 connected to the first battery 86 and the second battery 92. In this example, the boost converter 100 is provided with an inductor 140 connected to the first positive terminal 88, and in series with the first battery 86. The boost converter 100 is also provided with a switch 142, a capacitor 144, and a diode 146. The switch 142 and the capacitor 144 are in a parallel arrangement with the first battery 86 as shown in FIG. 6. When the switch 142 is closed, current flows through the inductor 140 and the inductor 140 stores energy by generating a magnetic field. When the switch 142 is open, current flows through the inductor 140, but the amount of current is reduced as the impedance is higher. The magnetic field that was previously created is reduced to maintain the current towards the load, i.e., the second battery 92, and the polarity across the inductor 140 switches. Thus, the voltage V₁ and the voltage across the inductor 140 are in series, thereby increasing the voltage at the output port 104. When the switch 142 is opened, the capacitor 144 supplies the current and the energy to the output port 104. By opening and closing the switch 142 at a sufficient rate, neither the inductor 140 nor the capacitor 144 will fully discharge in between charging stages, and the output port 104 will have a voltage that is greater than the first voltage V₁ provided to the input port 102. In some embodiments, the boost converter 100 is configured to have an efficiency of between 95% and 100%, or between 95% and 99%, or between 95% and 98% or between 95% and 97%. During this switching process, the diode 146 prevents the capacitor 144 from discharging through the switch 142. The boost converter 100 is also provided with a controller 148 that serves to actuate and deactuate the boost converter 100. The controller 148 is coupled to the switch 142 and provides a control signal to control the opening and closing of the switch 142. In one embodiment, the control signal is a pulse-width modulated signal having a duty cycle in which the duty cycle is controlled to control the magnitude of the variable voltage Vᵥ. In general, as the duty cycle increases, the variable voltage Vᵥ increases, and as the duty cycle decreases, the variable voltage Vᵥ decreases. The boost converter 100 can be deactuated by enabling the controller 148 to supply a zero duty cycle control signal to the switch 142 thereby maintaining the switch 142 in the open state. The switch 142 can be a semiconductor switch, such as a a bipolar junction transistor, a field effect transistor, an insulated-gate bipolar transistor or the like. In one embodiment, the switch 142 can have a voltage rating of less than the charging voltage. In some embodiments, the switch 142 can have a voltage rating of between 2% and 50% of the charging voltage. In some embodiments, the switch 142 can have a voltage rating between 50 volts and 5 volts, or between 50 volts and 10 volts. For example, the switch 142 can have a voltage rating of 12 V, 24 V, or 48 V.

The boost converter 100 can be provided with an input device 150 coupled to the controller 148 for providing an input signal to the controller 148. The controller 148 can be configured to receive input indicative of the magnitude of the variable voltage Vᵥ prior to creating and providing the control signal to the switch 142. For example, the input device 150 can be an electric vehicle supply equipment control system that is coupled to the controller 148 that determines the parameters for charging the battery pack 42 (ideally on a battery pack 42 by battery pack 42 basis). Or, the input device 150 can be a keypad, smart phone or other device configured to receive manual input from a user, such as a particular make and model of electric vehicle, voltage and current requirement of the battery pack 42, for example. Or, the input device 150 can be one or more sensors (current sensor, voltage sensor, temperature sensor, etc.) that monitor one or more parameters of the charging process to provide input to the controller 148 in real-time. The parameters can be charging current, Vₛₚ, state of charge, battery temperature or the like.

As known in the art, power is defined as V²/R. Because certain of the components of the boost converter 100 are only subjected to the first voltage V₁, rather than the voltage Vₛₚ, the components (e.g., the inductor 140, the switch 142, the diode 146 and the capacitor 144) within the boost converter 100 can be selected to have lower power requirements. Because components having lower power requirements also have lower resistance and other desirable features, such as higher switching rates, the boost converter 100 can be implemented at a lower cost and a higher efficiency than the conventional bi-directional inverter 20 and the Dc to DC converter 38 discussed above.

In some embodiments, the first battery 86 and/or the second battery 92 may be characterized as a “smart battery” having a battery management system. A battery management system is an electronic system having a processor and/or other components that manages a rechargeable battery (cell or battery pack), such as by protecting the rechargeable battery from operating outside a pre-defined safe operating area, monitoring the rechargeable battery state, e.g., total voltage, voltages of individual cells, minimum and maximum cell voltage or voltage of periodic taps, average temperature, coolant intake temperature, coolant output temperature, temperatures of individual cells, state of charge, current in or out of the rechargeable battery, maximum charge current, maximum discharge current, energy delivered since last charge, internal impedance of a cell, charge delivered or stored, total energy delivered since first use, total operating time since first use, total number of cycles, and the like. The battery management system may also include a central controller that communicates internally with cell level or hardware, or externally with another computer, such as a central charging station controller, laptop, smart phone or tablet computer. Any suitable communication system can be used by the battery management system(s), such as a serial communication link, a CAN bus, a DC-bus, or one or more wireless communication system, such as bluetooth transceiver, cellular transceiver or wi-fi transceiver. In some embodiments, the battery management system may also control the environment for the first battery 86 and/or the second battery 92.

In some embodiments, the present disclosure describes a method of making the battery charging station 82. To make the battery charging station 82, the first leads 122a and 122b of the first battery charger 120 are connected to the first positive terminal 88 and the first negative terminal 90 of the first battery 86, and the second leads 126a and 126b of the second battery charger 124 are connected to the second positive terminal 94 and the second negative terminal 96 of the second battery 92. The first positive terminal 88 of the first battery 86 is connected to the input port 102 of the boost converter 100, and the second negative terminal 96 of the second battery 92 to the output port 104 of the boost converter 100. These steps can be conducted in any order or simultaneously. Also, the sensors or other components of the input device 150 can be connected in-circuit or on the first battery 86 or the second battery 92 so as to be capable of monitoring various parameters of the charging process. Again, the input device 150 can be installed in—circuit and/or on the first battery 86 and/or the second battery 92 in any order or simultaneously with the other steps of making the battery charging station 82.

Once the battery pack 42 is connected to the first negative terminal 90, and the second positive terminal 94, as shown in FIG. 5, the boost converter 100 can be actuated to begin charging the battery pack 42. Input can be received by the input device 150 as described above, and information can be provided to the controller 148 so that the controller 148 can supply control signals to the switch 142. The switch 142 is turned on and off at a rate controlled by the controller 148 thereby causing the variable voltage Vᵥ to increase as discussed above.

From the above description, it is clear that the inventive concept(s) disclosed herein are well adapted to carry out the objects and to attain the advantages mentioned herein, as well as those inherent in the inventive concept(s) disclosed herein. While the embodiments of the inventive concept(s) disclosed herein have been described for purposes of this disclosure, it will be understood that numerous changes may be made and readily suggested to those skilled in the art which are accomplished within the scope and spirit of the inventive concept(s) disclosed herein.

What is claimed is:

1. A battery charging station, comprising:
a first battery having a first positive terminal and a first negative terminal and producing a first voltage between the first positive terminal and the first negative terminal;
a second battery having a second positive terminal and a second negative terminal and producing a second voltage between the second positive terminal and the second negative terminal;
a boost converter having an input port coupled to the first positive terminal and an output port coupled to the second negative terminal and producing a third voltage at the second negative terminal greater than the first voltage; and
at least one battery charger having first leads coupled to the first positive terminal and the second negative terminal, and second leads coupled to the second positive terminal and the second negative terminal for charging the first battery and the second battery from an external power source.

2. The battery charging station of claim 1, wherein the first voltage is less than the second voltage.

3. The battery charging station of claim 2, wherein the first voltage is less than one-half of the second voltage.

4. The battery charging station of claim 2, wherein the first voltage is less than one-fourth of the second voltage.

5. The battery charging station of claim of claim 1, wherein the first battery includes a plurality of first battery units interconnected so as to provide X first battery units in series and Y first battery units in parallel, and wherein the second battery includes a plurality of second battery units interconnected so as to provide A second battery units in series and B second battery units in parallel, and wherein X is greater than A, and B is greater than Y.

6. A method comprising the steps of:
a. connecting first leads of at least one battery charger to a first positive terminal and a first negative terminal of a first battery, and second leads to a second positive terminal and a second negative terminal of a second battery; and
b. connecting the first positive terminal of the first battery to an input port of a boost converter, and the second negative terminal of the second battery to an output port of the boost converter to make a battery charging station.

7. The method of claim 6, wherein step a occurs prior to step b.

8. The method of claim 6, wherein step b occurs prior to step a.

9. The method of claim 6, wherein steps a and b occur simultaneously.

10. A battery charging station, comprising:
a first battery having a first positive terminal and a first negative terminal and producing a first voltage;
a second battery having a second positive terminal and a second negative terminal and producing a second voltage;
a boost converter coupled in series between the first battery and the second battery, and configured to selectively produce a third voltage at the second negative terminal greater than the first voltage; and
at least one battery charger having first leads coupled to the first positive terminal and the second negative terminal, and second leads coupled to the second positive terminal and the second negative terminal for charging the first battery and the second battery from an external power source.

11. The battery charging station of claim 10, wherein the first voltage is less than the second voltage.

12. The battery charging station of claim 11, wherein the first voltage is less than one-half of the second voltage.

13. The battery charging station of claim 11, wherein the first voltage is less than one-fourth of the second voltage.

14. The battery charging station of claim 10, wherein the first battery includes a plurality of first battery units interconnected so as to provide X first battery units in series and Y first battery units in parallel, and wherein the second battery includes a plurality of second battery units interconnected so as to provide A second battery units in series and B second battery units in parallel, and wherein X is greater than A, and B is greater than Y.
